(19) United States
(12) Patent Application Publication
(10) Pub. No.: US 2006/0032361 A1
(43) Pub. Date: Feb. 16, 2006

(54) Wind turbine assembly

(75) Inventors: Maurice Deschamps, Brantford (CA); Gary E. Thaxter, Brantford (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: 1592834 ONTARIO INC.

(21) Appl. No.: 11/199,172

(22) Filed: Aug. 9, 2005

Related U.S. Application Data
(60) Provisional application No. 60/599,861, filed on Aug. 10, 2004.

(51) Int. Cl. G10H 1/00

(52) U.S. Cl. 84/600

(57) ABSTRACT

A wind turbine including a frame, a driveshaft rotatably mounted on the frame, and a body adapted to be driven by a wind. The body includes one or more spiral vanes attached to the driveshaft. The vanes may be assembled from a number of vane layers. The axis of rotation of the wind turbine is intended to be normally vertical, but it could be operated at other angles, including horizontal.

### REFERENCE TO RELATED APPLICATION(S)

This application is a formal application based on and claiming the benefit of provisional application No. 60/599,861, filed Aug. 10, 2004.

### BACKGROUND OF THE INVENTION

This invention relates to wind turbines, and particularly to those intended to be operated about a vertical axis, though not necessarily restricted to a vertical axis.

Wind turbines which can be driven for various purposes, for example to generate electricity, are known. For example, U.S. Pat. No. 5,664,418 (Walters) discloses a vertical axis wind and water turbine including a series of crescent-shaped deflector vanes.

Different types of wind-driven power-generating installations are known. Many include a propeller type of generating device mounted on a wind tower in which the propeller is adapted to be driven by the wind. However, the propeller type of generating device has a number of disadvantages. For example, because the propeller blades are required to be very large in order to turn a generator and drive gears associated therewith, the propeller can be dangerous when the wind is blowing. The propeller blades (or rotor blades) typically do not turn unless the wind speed is at or above a threshold level. Also, because the wind tower is typically 50 to 60 meters tall, the tower is subjected to extreme pressure during operation. In addition, every time the direction of the wind shifts, the propeller blades must be turned into the wind.

In contrast, wind turbines are known which can be driven by relatively light winds. Unlike propeller-type wind-driven generators, known wind turbines typically can be driven by winds coming from various directions without changing position.

Physical contact between the wind and the wind turbine blades, or vanes, is necessary to transfer power from the wind to the wind turbine. Accordingly, a wind turbine which presents a larger surface against which the wind can push will transfer relatively more power from the wind that a wind turbine which presents a somewhat smaller surface. A vortically-curved spiral surface—i.e., one which is generally helicoid—will present a surface against which the wind pushes, regardless of the wind's direction. However, it is important that the wind turbine be precisely balanced, otherwise vibration which could destroy the wind turbine may result.

Known wind turbines suffer from a number of deficiencies. They tend to be heavy, and because they are difficult to make, they are relatively expensive. This is because known methods of making a wind turbine which includes vortically curved vanes involve a number of practical difficulties, and such methods are therefore prohibitively expensive. Where the vanes present the maximum surface area (i.e., extending from a central driveshaft outwardly), or where the wind turbine is required to be relatively large (e.g., in order to generate a relatively large amount of electricity), the difficulties encountered in manufacturing are exacerbated. In addition, there is a need for improved efficiencies generally in the operation of wind turbines driven by wind or other winds.

There is therefore a need for an improved wind turbine.

### SUMMARY OF THE INVENTION

In view of the above, it is an object of this invention to provide an improved wind turbine. The assembly is intended primarily for operation about a vertical axis, but it will be appreciated that it could be operated about a horizontal or other axis if desired.

In its broad aspect, the invention provides a wind turbine including a frame, a driveshaft rotatably mounted on the frame, and a body adapted to be driven by the wind. The body has two or more vanes extending outwardly from the driveshaft. Each vane is vertically curved for receiving the wind so that the wind causes the body and the driveshaft to rotate.

In one aspect, the body is formed from a number of identical layers, laid on top of each other, slightly offset radially from each other to form the desired spiral shape. In another aspect, the shape may be molded in one piece.

In another aspect, the invention also includes a generator connected to the driveshaft to generate electricity.

In the preferred embodiment, there are three vanes attached to the driveshaft, the vanes being diametrically opposed to each other to define a double helix positioned symmetrically relative to the driveshaft. However, two vanes or more than three vanes could be adopted if desired.

In yet another of its aspects, the invention includes a method of making the wind turbine, including the steps of providing a driveshaft and then assembling successive vane layers on the driveshaft and securing each one successively offset slightly from its neighbor to produce the desired spiral shape. Alternatively, each layer could be attached to each other first, and the assembled layers could subsequently by attached to a driveshaft.

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

FIG. 1 is a perspective view of a preferred embodiment of the wind turbine of the invention;

FIG. 2 is a side view of the preferred embodiment;

FIG. 3 is a perspective view of the preferred embodiment, showing one layer of the multi-layer vane removed;

FIG. 4 is a plan view of the body in the preferred embodiment;

FIG. 5 is plan view of one of the vane layers;

FIG. 6 is a corresponding cross-section of the vane layer;

FIG. 7 is a cross-section of adjacent vane layers, showing engagement pins;

FIG. 8 is a plan view showing the offset of two adjacent vane layers;

FIG. 9 is a perspective view showing three adjacent vane layers;

FIG. 10 is a perspective view showing the three arms which make up a single vane layer;

FIG. 11 is a perspective view of a variation of FIG. 1, which rotates clockwise (as viewed from above);

FIG. 12 is a plan view of a vane layer in a 4-vane version of the invention; and

FIG. 13 is a plan view of a vane layer in a 2-vane version of the invention.

### DETAILED DESCRIPTION OF THE INVENTION

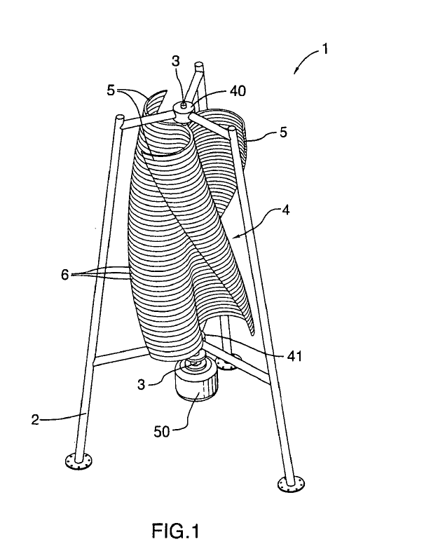

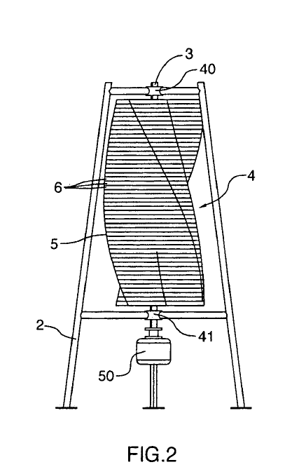

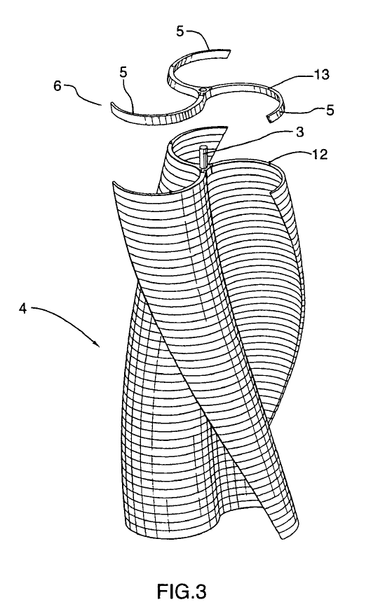

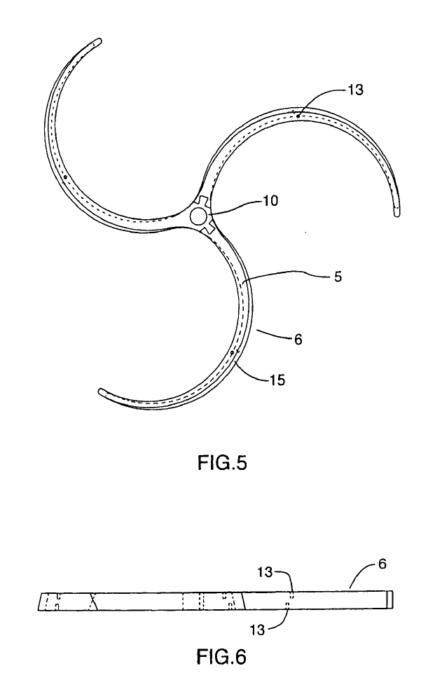

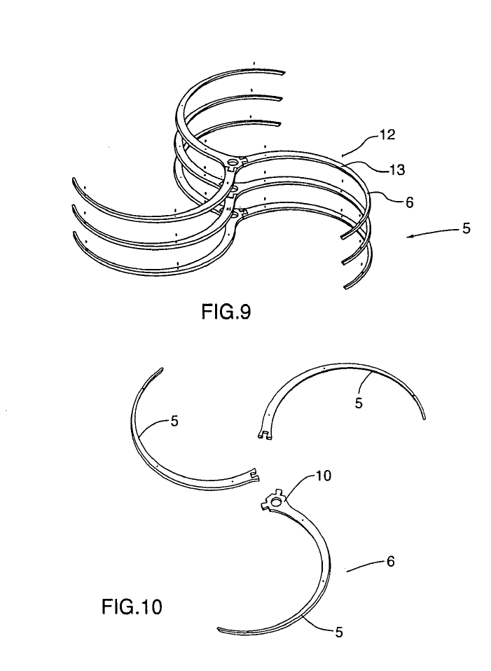

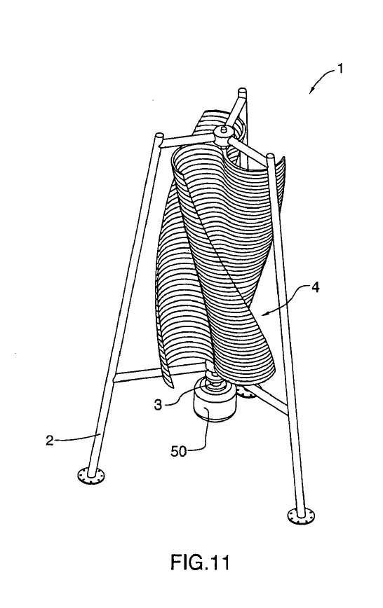

A preferred embodiment of the invention is illustrated in FIGS. 1-10.

The wind turbine 1 preferably includes a frame 2, a central driveshaft 3 rotatably mounted on the frame between upper and lower support bearings in bearing housings 40 and 41, and a body 4 with vanes 5 extending therefrom, symmetrically positioned relative to the driveshaft. Each vane is vertically curved for receiving the wind so that the wind causes the body 4 (and consequently the driveshaft 3) to rotate. In the preferred embodiment, each vane 5 is formed from a plurality of vane layers 6, as will be described.

Preferably, the wind turbine 1 also includes a generator 50 connected to the driveshaft 3 to generate electricity. However, if desired, the driveshaft could instead be directly connected, perhaps via a clutch, transmission or variable gearing, to drive a device directly, such as a pump for example. Other uses could include mounting on poles for lighting, using on boats for battery charging or other purposes, and myriad other purposes. It should be understood that the invention relates to the structure of the wind turbine itself, rather than to what is operated by the wind turbine.

As illustrated, the driveshaft 3 preferably is maintained by the frame 2 in a substantially vertical position, though it will be appreciated that the wind turbine could be operated about any axis.

In the preferred embodiment, where there are multiple vane layers 6, each vane layer is offset radially from its neighbor, to form the desired helix. For efficiency of manufacture (reduced waste in cutting), each vane layer may be formed from three vane sections secured to a central hub (not shown), or as in the illustrated and preferred embodiment, one of the vanes has an integral hub portion 10 to which the other vanes are secured (see FIGS. 5, 10 and 14). Each vane layer is positioned by virtue of dowel pins 12 in holes 13 which are offset from each other sufficiently to produce the desired offset.

Preferably, especially for larger wind turbines, each vane layer 6 may have one or more cavities 18 to reduce the overall weight. Preferably in such an arrangement the top and bottom vane layers are not provided with these cavities, so that there is no opening into the interior of the vanes. In smaller designs (i.e., where the weight of the assembled body is less of a concern), it may be unnecessary and/or preferable to avoid such cavities.

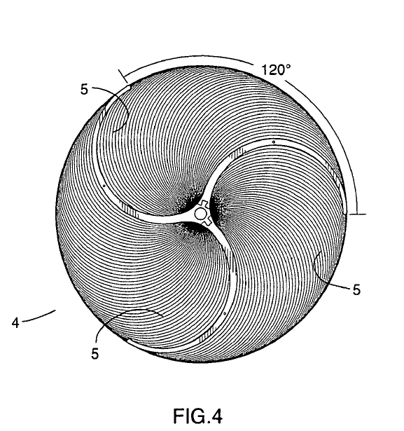

Preferably, in the three-vane preferred embodiment, each vane is offset by a total of 120 degrees from top to bottom, i.e. there is 120 degrees of “twist” as shown in FIG. 4, and each layer is ¾ inches in thickness. The desired height of the overall wind turbine therefore determines the necessary offset angle χ of each layer (see FIG. 8). For example, a 36-inch high wind turbine would require 48¾-inch vane layers, each therefore needing to be offset by 2.5 degrees from its neighbor (48×2.5 degrees=120 degrees of total twist). Obviously, the thickness of each layer could be varied as desired, which would affect the number of vane layers required for any given desired height, which in turn would affect the amount of offset needed between neighboring vane layers. Similarly, it is not essential that there should be 120 degrees of twist, though that amount has been found to be very satisfactory in terms of removing energy from the windstream and then shedding the air. Too small an amount of twist might not extract sufficient energy, and too much twist might lose efficiency by not shedding or spilling “used” air sufficiently.

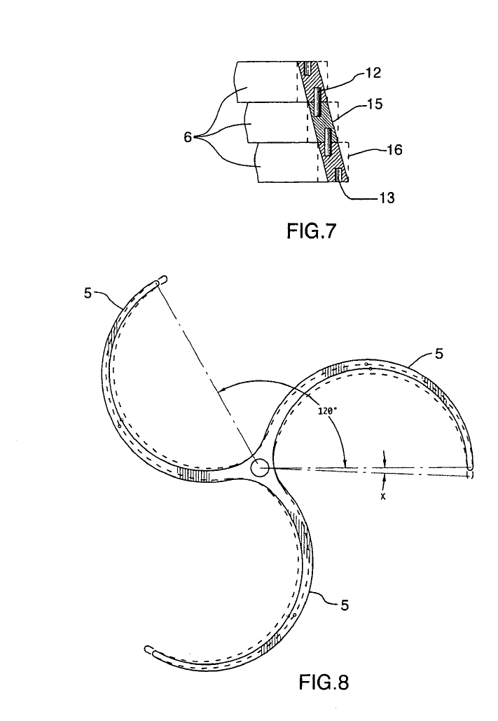

The required degree of offset between neighboring vane layers also dictates the angle at which the side edges 15 of the vane layers must be formed or cut to produce a smooth profile (see FIG. 7). If the side edges were not angled, the helical shape of the overall vane would proceed in a number of small steps, instead of being smooth, as can be seen from FIG. 7, where the dotted lines 16 indicate what the shape would be if the side edges were not angled.

The vane layers 6 may be formed from a wide variety of materials, but in the preferred embodiment, a Baltic birch laminate is used, for a desirable combination of relatively high strength and relatively low weight. Each layer is glued to its neighbor, though other securing means could be used if desired. A stack of vane layers is assembled from bottom to top, using the dowel pins 12 to position each layer, and glue to assist in holding the layers together. Other preferred materials include any suitable thermoplastics, aluminum, fiberglass, carbon fiber, wood and Kevlar (trademark).

It should be understood that any suitable method of attaching the layers together could be used, and that dowel pins 12, though certainly advantageous, are not essential.

The driveshaft 3 may include keys (not shown) equally radially spaced apart from each other, to be received in corresponding keyways in the hub portion. However, in many embodiments, it is sufficient to apply glue to the area of the central hole through the hub portion as each vane layer is added, provided that the diameter of the hole is a close match to the diameter of the driveshaft.

Preferably, the body is painted or otherwise sealed after assembly, to provide a smoother surface and to prevent moisture from entering. Light sanding is desirable prior to painting, with reasonable care being taking to avoid creating an imbalance.

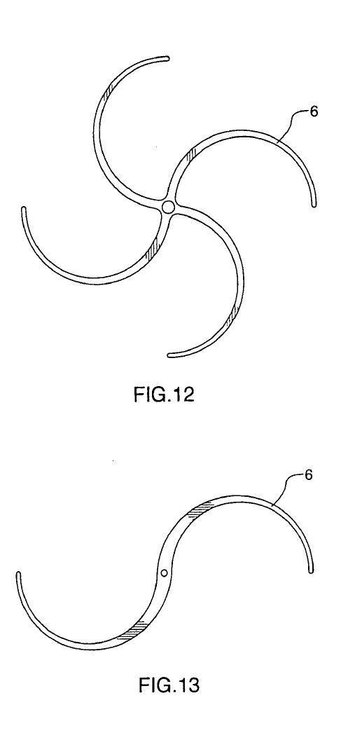

In the preferred embodiment, as shown in FIG. 1, the vanes are arranged such that the leading edge of the vanes is at the top. More air thus tends to exit or shed downwardly, thus creating an upward force on the vanes. This partially supports the weight of the wind turbine, thus relieving the bearing beneath the wind turbine of some of its weight-bearing responsibility, and thus increasing its life and reducing maintenance. However, as shown in FIG. 11, the opposite configuration could be used if desired, though this would result in somewhat more downward force on the bearing.

Similarly, the wind turbine could be arranged to rotate counterclockwise as seen from above, as in FIG. 1, or by changing the sweep direction of the vanes, to rotate clockwise.

It will be appreciated by those skilled in the art that the invention can take many forms, and that such forms are within the scope of the invention as claimed. Therefore, the spirit and scope of the appended claims should not be limited to the descriptions of the preferred versions contained herein.

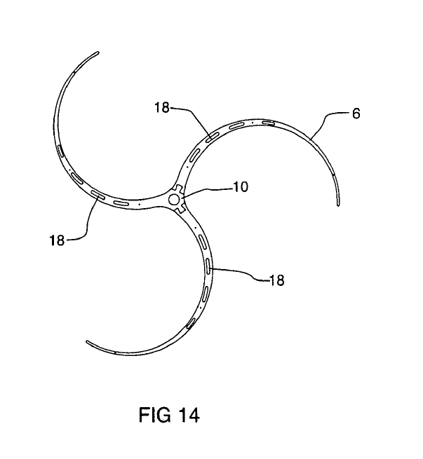

Many variations on the preferred embodiment(s) described above are conceivable within the broad scope of the invention, and will be apparent to those knowledgeable in the field of the invention. It should therefore be understood that the claims which define the invention are not restricted to the specific embodiment(s) described above. Possible variations include, for example, having four vanes, as shown in FIG. 12, or only two vanes, as shown in FIG. 13. Theoretically, there could be more than four vanes, so that is not excluded from the invention, but obviously at a certain point it becomes impractical to have too many vanes.

Further variations may be apparent or become apparent to those knowledgeable in the field of the invention.

1. A wind turbine comprising:
a frame;
a driveshaft rotatably mounted on the frame;
a body adapted to be driven by wind, the body including at least two vanes attached to the driveshaft, each said vane forming a spiral about said driveshaft, for receiving the wind such that the wind causes the body and the driveshaft to rotate.

2. A wind turbine as in claim 1, wherein said body comprises a plurality of vane layers assembled to define said vanes, each said vane layer being offset slightly from its neighbor to produce said spiral.

3. A wind turbine according to claim 2, in which interior vane layers include at least one cavity for weight reduction.

4. A wind turbine as in claim 1, in which the body includes three vanes attached to the driveshaft, said vanes being radially spaced apart from each other about the driveshaft to define a triple helix positioned symmetrically relative to the driveshaft.

5. A wind turbine as in claim 4, wherein each vane spirals through approximately 120 degrees.

6. A method of making a wind turbine having a body with at least two vertically curved vanes, the method comprising the steps of:
(a) providing a driveshaft; and
(b) assembling a plurality of vane layers consecutively on said driveshaft, each slightly offset from its neighbor, each said vane layer being shaped such that said layers form said at least two vortically curved vanes upon assembly thereof, each said layer being attachable to each layer adjacent thereto by at least one attachment means.
